(19) United States
(12) Patent Application Publication
(10) Pub. No.: US 2024/0117180 A1
(43) Pub. Date: Apr. 11, 2024

(54) COMPOSTABLE AND ANTIMICROBIAL MATERIAL FOR USE IN PACKAGING MATERIAL

(71) Applicant: Gene Benfatti, Plainfield, NJ (US)

(72) Inventor: Gene Benfatti, Plainfield, NJ (US)

(21) Appl. No.: 18/518,898

(22) Filed: Nov. 24, 2023

Related U.S. Application Data
(60) Provisional application No. 63/413,546, filed on Oct. 5, 2022.
(60) Provisional application No. 63/428,254, filed on Nov. 28, 2022.

(51) Int. Cl. C08L 67/02; C08J 3/20

(52) U.S. Cl. CPC C08L 67/02; C08J 3/203; C08J 2367/02; C08J 2467/04; C08L 2201/06; C08L 2203/16; C08L 2205/025

(57) ABSTRACT

A compostable and antimicrobial material for packaging products, in particular the packaging products for foodstuffs, vegetables, fruits, and the like. The compostable and antimicrobial material includes 1-5 parts polylactic acid, 93.5-99.4 parts of polybutylene terephthalate adipate, 0.6-1.5 parts of antimicrobial material, 0.1-0.5 parts of lubricant, 0.3-0.8 parts of antioxidant, 10-15 parts of filler, 1-3 parts of plasticizer, Defoamer 0.1-0.2 parts, antihydrolytic agent 0.5-1 part. The antimicrobial material includes the following parts by weight: 1-2 parts of halloysite nanotubes, 0.2-0.5 wormwood extract, 1.5-2 parts of ethanol, 0.3-0.6 parts of polyglyceryl sebacate, 0.4-0.7 parts of bamboo fiber, 0.1-0.3 parts of loofah fiber emulsion.

### CROSS-REFERENCE TO RELATED APPLICATIONS

This application claims priority from a U.S. provisional patent application Ser. No. 63/413,546, filed on Oct. 5, 2022, and a U.S. provisional patent application Ser. No. 63/428,254, filed on Nov. 28, 2022, both of which are incorporated herein by reference in its entirety.

### FIELD OF INVENTION

The present invention relates to polymeric materials, and more particularly, the present invention relates to compostable polymeric material with antimicrobial properties.

### BACKGROUND

Traditionally, the packaging articles are chiefly made from polyethylene and polypropylene. Polybags made from polyethylene are economical to manufacture at small and large scales. Such polybags are light in weight and are durable. Being waterproof, the polymeric packaging can be used for the storage and carrying of solids, semi-solids, and liquids. However, packaging materials made from polyethylene, polypropylene, and the like cannot be decomposed but can be photo-degraded under the right conditions which may take thousands of years. Plastic waste disposal is a major challenge in the modern world. Incineration treatment of plastic waste leads to air pollution and the greenhouse effect.

Degradable plastics are gradually replacing the non-degradable plastics packaging materials. Fully degradable plastics are commonly PBAT and PLA. PBAT is polybutylene terephthalate, which is a biodegradable aromatic polyester with low strength, high exercise elongation, and excellent flexibility. PLA is polylactic acid made of sugar, starch, cellulose, and other biomass materials as raw materials. Fermentation of the raw materials makes lactic acid, which is converted into polylactic acid polymer materials. Although the use of degradable plastics seems to be promising, degradable plastics suffer from many other kinds of drawbacks.

Packaging products, such as poly bags made from degradable materials are susceptible to the growth of microbes. The microbes easily accumulate on the packaging and grow, which can contaminate the hands of a person carrying the item. In the case of food items, the risk of food spoilage by microbes increases due to such packaging.

A need is therefore appreciated for a compostable material with antimicrobial properties for packaging

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a compostable packaging material with antimicrobial properties.

Another object of the present invention is that packaging material can be used in the manufacturing of reusable and disposable packaging products.

Still, another object of the present invention is that the packaging material can be used for food packaging.

In one aspect, disclosed is a compostable antimicrobial material for packaging products, wherein it includes the following parts by weight: 1-5 parts polylactic acid, 93.5-99.4 parts of polybutylene terephthalate adipate, 0.6-1.5 parts of antimicrobial material, 0.1-0.5 parts of lubricant, 0.3-0.8 parts of antioxidant, 10-15 parts of filler, 1-3 parts of plasticizer, Defoamer 0.1-0.2 parts, and antihydrolytic agent 0.5-1 part.

In one aspect, the antimicrobial material is prepared by following steps: after purification of halloysite nanotubes, mixed with wormwood extract and ethanol, vacuumed to 0.1-0.2 MPa, stirred for 30-45 min, restored to normal pressure, stirred for 15-20 min, stirred three times under circulating vacuum and atmospheric pressure, washed, filtered, and dried to obtain antimicrobial halloysite nanotubes.

In one aspect, polyglycerol sebacate was dissolved with hexafluoroisopropanol to make a spinning liquid with a concentration of 20-25 wt. %, and electrospinning to obtain PGS fiber; The PGS fiber, bamboo fiber, loofah fiber emulsion and the antimicrobial halloysite nanotubes are mixed, dried, and ground to obtain an antimicrobial material.

In one aspect, the antimicrobial material comprises the following parts by weight of components: 1-2 parts of halloysite nanotubes, 0.2-0.5 wormwood extract, 1.5-2 parts of ethanol, 0.3-0.6 parts of polyglyceryl sebacate, 0.4-0.7 parts of bamboo fiber, 0.1-0.3 parts of loofah fiber emulsion.

In one aspect, the loofah fiber emulsion is made by the following method: the loofah and water were mixed, beaten and homogenized to prepare the slurry, and the emulsifier, tea tree oil and dopamine hydrochloric acid buffer were added to the slurry, stirred at 25-30° C. for 5-6 h, homogenized, and the mass ratio of slurry, emulsifier, tea tree oil and dopamine hydrochloric acid buffer was 1:(0.02-0.03):(0.05-0.1).

In one aspect, the filler comprises a mass ratio of 1:(0.2-0.5):(0.1-0.2) graphene oxide, eggshell membrane powder and polyvinyl alcohol. The filler is made by the following method: (1) The eggshell membrane powder is impregnated in silver nitrate solution for 20-24 h, sodium borohydride solution is added, stirred for 1-2 h, filtered, washed, dried, mixed with chitosan, acetic acid solution with a concentration of 1-1.5 wt. %, and pressed at a pressure of 0.08-0.12 MPa for 10-20 s, crushed, made into modified eggshell membrane powder; (2) Mix graphene oxide, surfactant and titanium trichloride and deionized water, raise the temperature to 180-190° C., keep warm for 5-6 h, cool, filter, wash, dry to obtain modified graphene oxide; and (3) The modified eggshell membrane powder, the modified graphene oxide, polyvinyl alcohol, glutaraldehyde and deionized water are mixed evenly, ultrasonic for 20-30 min, frozen at −(15˜20) ° C. for 1-2 h, vacuum dried for 46-48 h, ground to 2000-3000 mesh, and prepare filler. In one aspect, the mass ratio of chitosan and graphene oxide is (0.2-0.4:1).

In one aspect, the lubricant is selected from one or more of N,N-methylenebistearamide, polyethylene wax, zinc stearate; the plasticizer is selected from one or more of glycerol, epoxy soybean oil, or tributyl citrate; the defoamer is selected from one or more of the silicon ether copolymer defoamer, modified polydimethylsiloxane and glycerol polyoxypropylene polyoxyethylene ether; the antioxidant is selected from one or both of the antioxidant 1010 and antioxidant 168; the anti-hydrolyzing agent is Hy-Max-1010 type anti-hydrolytic agent.

In one aspect, the average molecular weight of polylactic acid is 50,000-100,000; the average molecular weight of polybutylene terephthalate adipate is 100,000-300,000.

In one aspect, disclosed is a method for preparing compostable antimicrobial materials for packaging products, the method comprises the following steps: (S1) Dry polylactic acid and polybutylene terephthalic acid butylene glycol terephthalate at 55-65° C. for 6-8 h, and then extrude and granulate to obtain masterbatch; (S2) The masterbatch is mixed with plasticizers, lubricants, antioxidants, fillers and defoamers, and granulated by extrusion to obtain compostable antimicrobial materials for packaging products. In S1 step, the extrusion temperature is 170-190° C.

### DETAILED DESCRIPTION

Subject matter will now be described more fully hereinafter with reference to the specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a compostable and antimicrobial packaging material for use in the manufacturing of reusable and disposable packaging products. In one implementation, the disclosed packaging material includes the following parts by weight of components: polylactic acid (PLA) 1-5 parts, polybutylene terephthalate adipate (PBAT) 93.5-99.4 parts, antimicrobial composition 0.6-1.5 parts, lubricant 0.1-0.5 parts, antioxidant 0.3-0.8 parts, filler 10-15 parts, plasticizer 1-3 parts, and defoamer 0.1-0.2 parts.

In one implementation, disclosed is a method of preparing the compostable and antimicrobial packaging material. First, the halloysite nanotubes can be purified, and then the purified halloysite nanotubes can be mixed with wormwood extract and ethanol, and then processed further to obtain antimicrobial halloysite nanotubes. The antimicrobial halloysite nanotubes can be used as an antimicrobial composition in compostable polymeric material.

For example, the antimicrobial halloysite nanotubes were prepared by first cleaning the halloysite nanotubes, and then the purified halloysite nanotubes were mixed with wormwood extract and ethanol, the composition was vacuumed to 0.1-0.2 MP, stirred for 30-45 min, restored to normal pressure, stirred for 15-20 min, stirred three times under circulating vacuum and atmospheric pressure, and thereafter washed, filtered, and dried to obtain the antimicrobial halloysite nanotubes. The antimicrobial halloysite nanotubes can be used with compostable polymeric material to obtain antimicrobial compostable packaging material. It is understood, however, that the antimicrobial halloysite nanotubes can be used as an antimicrobial composition for any other purpose or in any other product, and such use of the antimicrobial halloysite nanotubes is within the scope of the present invention. Also, the terms compostable, degradable, and biodegradable are interchangeably used herein and refer to being compostable.

In one implementation, polyglycerol sebacate was dissolved with hexafluoroisopropanol to make a spinning liquid with a concentration of 20-25 wt. % and the electrospinning was used to obtain PGS fiber. The PGS fiber, bamboo fiber, loofah fiber emulsion, and antimicrobial halloysite nanotubes were mixed, dried, and ground to obtain the disclosed packaging material.

Also disclosed is an antimicrobial halloysite nanotubes composition, a method of manufacturing the antimicrobial halloysite nanotubes, and the use of antimicrobial halloysite nanotubes in polymeric materials to obtain antimicrobial polymeric materials. The halloysite nanotubes have good biocompatibility, a high aspect ratio, and a specific surface area. Moreover, the presence of silicon elements and less hydroxyl structure on the outer wall, makes it hydrophobic, so it has good compatibility when blended with polylactic acid and PBAT. Moreover, the active ingredients and ethanol in the wormwood extract are loaded in the halloysite nanotubes, the active ingredients and ethanol in the wormwood extract have a strong bacteriostatic effect, and ethanol has a strong bacteriostatic effect and a similar chemical structure to ethylene, which can be compared with ethylene receptors bind tightly to inhibit ethylene synthesis, delay chlorophyll decomposition, reduce respiration rate, delay the aging of fruits and vegetables, thereby playing an effective preservation role, prolonging storage period and shelf life, so halloysite nanotubes loaded with wormwood extract and ethanol have bacteriostatic and fresh-keeping effects.

Polyglycerol sebacate is a completely biodegradable material for biomedical applications, which is dissolved and electro-spun to obtain PGS fiber. The biodegradable PGS fiber and bamboo fiber are used as the outer wrapping material. PGS fiber under the adhesion of loofah fiber emulsion, fibers, and bamboo fibers overlap each other on halloysite nanotubes to form a porous structure, which complements the pores on halloysite nanotubes, thereby prolonging the release path of wormwood extract and ethanol, prolonging the antimicrobial and fresh-keeping time of antimicrobial materials. While each raw material is degradable raw materials, considering antimicrobial, fresh-keeping effect, and biodegradability, PGS fiber has good compatibility with polylactic acid. It can improve the compatibility of antimicrobial materials and masterbatches such as polylactic acid; improve the dispersion of antimicrobial materials in masterbatches such as polylactic acid; and improve the antimicrobial effect, and the antimicrobial materials made; thus, the use in packaging products can be long-term antimicrobial and long-term preservation that can extend the shelf life of food, fruits, vegetables, and the like.

Optionally, the antimicrobial composition comprises the following components by weight: 1-2 parts of halloysite nanotubes, 0.2-0.5 parts of wormwood extract, 1.5-2 parts of ethanol, 0.3-0.6 parts of polyglycerol sebacate, 0.4-0.7 Parts bamboo fiber, 0.1-0.3 parts loofah fiber emulsion.

By adopting the above technical scheme, wormwood extracts with bacteriostatic function, and ethanol with the function of reducing ethylene release can be loaded on the halloysite nanotubes. The loofah fiber emulsion can be used as an adhesive. The PGS fiber and bamboo fiber can be mixed as the outer layer of the three-dimensional network, which is coated on halloysite nanotubes. the pore structure of the outer layer of the three-dimensional network forms a better pore complement to the pore structure on halloysite nanotubes. This prolongs the release path of wormwood extract and ethanol, thus prolonging the bacteriostatic and fresh-keeping time.

In one implementation, disclosed is a method of preparing the loofah fiber emulsion. The loofah and water were mixed, beaten, and homogenized to prepare a slurry. To the slurry was added a suitable emulsifier, tea tree oil, and dopamine hydrochloric acid buffer. The mixture was stirred at 25-30° C. for 5-6 h and homogenized. The mass ratio of slurry, emulsifier, tea tree oil, and dopamine hydrochloric acid buffer was 1:(0.02-0.03):(0.05-0.1).

By adopting the above technical scheme, the slurry made by mixing and crushing loofah with water contains crushed loofah fiber. The crushed loofah fiber has the effect of bacteriostasis, moisture-proof and odor-proof. An emulsifier is used to improve the dispersion of slurry. The tea tree oil can increase the hydrophobicity of slurry and improve the barrier of slurry to water vapor. The tea tree oil itself has a wide antimicrobial spectrum and strong antimicrobial activity. The tea tree oil has been shown to be effective against Staphylococcus aureus, E. coli, Candida albicans, etc. The strong natural antimicrobial activity of the tea tree oil can improve the antimicrobial ability of slurry, which then improves the antimicrobial effect of antimicrobial composition for use in packaging materials. The dopamine buffer can be autoxidized with water to produce polydopamine. Polydopamine is a multifunctional new biomimetic material with good biocompatibility and excellent adhesion. Polydopamine can enhance the adhesion ability of loofah fiber emulsion, improving the adhesion of bamboo fiber and PGS fiber. The bonding fastness of fiber and halloysite nanotubes improves the stability of the outer layer of the three-dimensional network and prolongs the sustained release effect of bacteriostatic and fresh-keeping ingredients.

Optionally, the filler comprises graphene oxide with a mass ratio of 1:(0.2-0.5):(0.1-0.2):(0.1-0.2). By adopting said technical scheme, graphene oxide has a huge specific surface area and good chemical stability. The graphene oxide can cause microfilament protein disorder on the cell wall, thereby damaging microfilament protein, and then causing collapse and forming holes, thereby weakening the survival and reproduction ability of cells. This improves the antimicrobial ability of the filler. The multilayer structure of graphene oxide can extend the passage time of water molecules and oxygen inside the material and improve the antimicrobial properties and water vapor impermeability.

The filler may also contain eggshell membrane powder that is located between the eggshell and egg white, which has the role of preventing the invasion of external microorganisms. The use of eggshell membrane powder provides good antimicrobial and barrier properties. The eggshell membrane is in a cross-network structure that can extend the passage time of water vapor, and improve the durability of antimicrobial ability, and barrier ability. The use of polyvinyl alcohol as a binder material results in the graphene oxide and eggshell membrane powder adhering together. When the filler is blended with polylactic acid, it can improve the compatibility of graphene oxide and eggshell film powder, and polylactic acid, can make the filler fully and uniformly dispersed in polylactic acid and PBAT to improve the mechanical strength and antimicrobial properties of antimicrobial composition.

In one implementation, the filler was made by the following method: First, the eggshell membrane powder was impregnated in silver nitrate solution for 20-24 h; sodium borohydride solution was added; stirred for 1-2 h; filtered; washed; dried; and mixed with chitosan and acetic acid solution (concentration of 1-1.5 wt. %); Pressure in the range of about 0.08-0.12 MPa was applied for 10-20 s to crush the solids into modified eggshell membrane powder. Second, graphene oxide, surfactant, and titanium trichloride were mixed in deionized water. The temperature of the mixture was raised to 180-190° C. The mixture was then kept warm for 5-6 hours. Then cooled, filtered, washed, and dried to obtain modified graphene oxide. Third, the modified eggshell membrane powder, the modified graphene oxide, polyvinyl alcohol, glutaraldehyde, and deionized water were mixed evenly; then sonicated for 20-30 min; frozen at 15-20° C. for 1-2 h; and vacuum dried for 46-48 h; grounded to 2000-3000 mesh to prepare the filler.

By adopting the above technical scheme, the eggshell membrane presents a cross-linked network structure, which is impregnated in silver nitrate solution, and then reduced by sodium borohydride to make eggshell membrane powder loaded with nano-silver particles. With the use of the adhesion of chitosan, the eggshell membrane powder loaded with nano-silver is adhered together, and a relatively dense modified eggshell membrane powder is formed after pressing. The fastness of the eggshell membrane and nano-silver particles is improved, and the release time of nano-silver is prolonged. Chitosan is not only used as a binder but also as a polymer adsorbent. It has good biocompatibility and degradability and can adsorb ethylene and odor.

Then titanium dioxide is loaded on graphene oxide, which can be used as a photocatalyst to catalyze the ethylene released by fruits and vegetables, so that it is converted into carbon dioxide, thereby delaying the aging of fruits and vegetables. Finally, the modified graphene oxide and modified eggshell membrane powder are mixed with polyvinyl alcohol and freeze-dried. The graphene oxide that has not been reduced by titanium trichloride still contains active hydroxyl groups, carboxyl groups, etc., which can electrostatically interact with the free amine group on chitosan, and under the adhesion of polyvinyl alcohol, a filler with a porous structure is made. The porous structure allows the internal graphene oxide and eggshell membrane powder to slowly be released. Titanium dioxide on graphene oxide and the silver nano particles on the eggshell membrane powder are gradually released to form antimicrobial complementarity and fresh-keeping complementarity. Extend the preservation and antimicrobial time, so that the packaged product still has a good antimicrobial and fresh-keeping effect after multiple uses.

In certain implementations, the mass ratio of chitosan and graphene oxide can be (0.2-0.4): 1 optionally. By adopting said technical scheme, the active hydroxyl group and carboxyl group on graphene oxide can electrostatically interact with the upstream ionized amino group of chitosan, improve the binding fastness of graphene oxide and chitosan, and improve the stability of the filler.

In certain implementations, the lubricant can optionally be selected from one or more of the N,N-methylenebistearamide, polyethylene wax, and zinc stearate. The plasticizer can be selected from one or more of glycerol, epoxy soybean oil, and tributyl citrate. The defoamer can be selected from one or more of the silicon enigma copolymer defoamers, modified polydimethylsiloxane and glycerol polyoxypropylenepolyoxyethylene ether. The antioxidant can be selected from one or both antioxidant 1010 and the antioxidant 168. By adopting the above technical solutions, plasticizers can improve the fluidity of materials; increase the temperature range of material processing; and improve the dispersion between antimicrobial materials, polylactic acid, and polybutylene terephthalate. Moreover, the use of appropriate plasticizers can also improve the crystallization rate of materials and reduce the cooling time of the film during processing.

In certain implementations, the weight of polylactic acid can optionally be in a range of about 50,000-100,000. Polybutylene terephthalate adipic acid ester can have an average molecular weight of 100,000-300,000. By adopting the above technical scheme, the average molecular weight of polylactic acid reaches 50,000-100,000, selected from the model 4032 D type polylactic acid the melt flow rate is 10-20 g/10 min, and the average molecular weight is 10-300,000 PBAT selected from TH801T; the melt flow rate is 3-5 g/10 min; and the terminal acid value content is 10-30 mg/I; the two have good surface polarity and biocompatibility.

In the second aspect, the present application provides a method for preparing compostable antimicrobial materials for reusable or single-use packaging products, using the following technical solutions: First, dry polylactic acid and polybutylene terephthalic acid butylene terephthalate at 55-65° C. for 6-8 h, and then extrude and granulate to obtain masterbatch. Second, mix the master batch with plasticizers, lubricants, antioxidants, fillers, and defoamers evenly; extrude and granulate to prepare compostable antimicrobial materials for reusable or single-use packaging products. By adopting the said technical solution, polylactic acid and polybutylene terephthalate adipate are first blended and extruded to make a masterbatch, and then the masterbatch is blended and extruded with other components to improve the uniformity of antimicrobial materials and enhance mechanical strength.

In the above scheme, optionally, in the first step, the extrusion temperature can be 170-190° C. By adopting the said temperature range for extrusion, polylactic acid, and polybutylene terephthalate can be fully mixed to improve the uniformity of the blended master batch.

Disclosed composition, materials, and methods use PLA and PBAT as the main base materials and use compostable materials including bamboo fiber, PGS fiber, wormwood extract, and loofah fiber emulsion to prepare antimicrobial materials so that the antimicrobial materials made not only have good antimicrobial, deodorizing and preservation effects, but also have long antimicrobial, deodorizing, and fresh-keeping time. When used for reusable or single-use packaging products, after multiple uses, it still has good preservation and bacteriostatic effects, and each raw material can be compostable, suitable for food or non-food packaging, and bio-compostable.

The disclosed composition, materials, and methods use tea tree oil and dopamine hydrochloride buffer to improve the performance of loofah slurry. Tea tree oil increases the antimicrobial and water vapor barrier of loofah slurry. Dopamine hydrochloride buffer can form polydopamine with strong adhesion properties and can enhance the viscosity of loofah slurry. As a result, the loofah fiber emulsion formed not only has strong antimicrobial and fresh-keeping ability but also can improve bamboo fiber and PGS fiber adhesion. The adhesion strength of fibers and halloysite nanotubes prevents bamboo fibers and PGS fibers from falling off from halloysite nanotubes and losing the slow-release effect of halloysite nanotubes.

The eggshell membrane powder containing silver nanoparticles and the graphene oxide containing titanium dioxide are used to prepare fillers with bacteriostatic and fresh-keeping functions with polyvinyl alcohol and chitosan. Under the action of graphene oxide and chitosan, the porous structure of the filler can be improved. Polyvinyl alcohol is freeze-dried after blending wherein the rich pore structure can prolong the release time of eggshell membrane powder and graphene oxide, and the release time of silver nanoparticles and titanium dioxide can also be further extended, to make antimicrobial and fresh-keeping time. In reusable or single-use packaging products, after multiple uses, it can have a strong antimicrobial and fresh-keeping effect.

### EXAMPLES OF PREPARATION OF ANTIMICROBIAL MATERIALS

### Example 1

(1) After purification of 2 kg of halloysite nanotubes, it was mixed with 0.5 kg of wormwood extract and 2 kg of ethanol, vacuumed to 0.2 MPa, and stirred for 30 min, returned to normal pressure, stirred for 20 min. The steps of vacuum stirring and atmospheric pressure stirring were repeated in cycles three times. Thereafter, the solids were washed, filtrated, and dried to prepare antimicrobial halloysite nanotubes. The volume concentration of ethanol is 90%. The halloysite nanotubes were purified by the following method: 2 kg halloysite nanotubes after grinding, were mixed, and stirred with 3 kg deionized water and 0.6 kg sodium hexametaphosphate. The halloysite nanotubes were precipitated, and bottom impurities were removed. The upper suspension was centrifuged, dried, and grounded. Wormwood extract was made by the following method: mugwort was dried and then crushed. The mugwort was put into a non-woven bag and placed in the upper part of the Soxhlet extractor, the lower part contained ethanol, then heated to boiling with an electric heating jacket, and the steam leaching method was used to extract wormwood extract. The extract was concentrated to 70% solid content.

(2) 0.6 kg of poly(glycerol sebacate) was dissolved with hexafluoroisopropanol to make a spinning solution with a concentration of 25 wt. %. The solution was electro-spun to obtain PGS fiber.

(3) The PGS fiber, 0.7 kg bamboo fiber, 0.3 kg loofah fiber emulsion, and antimicrobial halloysite nanotubes are mixed, dried, and ground to obtain the disclosed compostable and antimicrobial material. The loofah fiber emulsion was made from loofah and water in a mass ratio of 3:1, and was mixed, beaten, and homogenized. The bamboo fiber is made of silane coupling agent K-H550 pretreatment.

### Example 2

(1) After purification, 1 kg of halloysite nanotubes were mixed with 0.2 kg wormwood extract and 1.5 kg ethanol. The mixture was vacuumed to 0.1 MP, stirred for 45 min, restored to normal pressure, and stirred for 15 min. The steps i.e., vacuum stirring and atmospheric pressure stirring were repeated three times. Thereafter, the solids were washed, filtered, and dried to obtain the antimicrobial halloysite nanotubes. The ethanol volume concentration was 90%.

The halloysite nanotubes were purified by the following method: 1 kg halloysite nanotubes after grinding were mixed and stirred with 3 kg deionized water and 0.5 kg sodium hexametaphosphate. The solids were precipitated, bottom impurities were removed, and the upper suspension was centrifuged. The solids were dried and grounded.

The wormwood extract is made by the following methods: mugwort is dried, crushed, put into a non-woven bag, placed in the upper part of the Soxhlet extractor, the lower part is ethanol, heated to boiling with an electric heating jacket, steam leaching method is used to extract wormwood extract, concentrated to 70% solid content.

(2) 0.3 kg of polypropylene sebacate was dissolved with hexafluoro isopropanol to make a spinning solution with a concentration of 20 wt. %, The spinning solution was electro-spun to obtain PGS fiber;

(3) The PGS fiber, 0.4 kg bamboo fiber, 0.1 kg loofah fiber emulsion, and antimicrobial halloysite nanotubes were mixed, dried, and grounded to obtain the antimicrobial packaging material. The loofah fiber emulsion was made from loofah in water. The loofah was mixed, beaten, and homogenized according to the mass ratio of 3:1. The bamboo fiber was made by silane coupling agent K-H550 pretreatment.

### Example 3

Steps described in Example 1 were used except the loofah fiber emulsion was prepared by the following method: the loofah in mass ratio of 4:1 were mixed with water, pulped, and homogenized to obtain a slurry. Emulsifier, tea tree oil, and dopamine hydrochloric acid buffer were added to the slurry and stirred at 25° C. for 6 h and homogenized. The mass ratio of slurry, emulsifier, tea tree oil, and dopamine hydrochloric acid buffer was 1:0.03:0.1. The emulsifier was Tween-80, and the concentration of dopamine hydrochloride in dopamine hydrochloric acid buffer was 2 mg/mL, trihydroxymethylaminomethane concentration of 10 mM, pH to 8.5.

### Example 4

Steps explained in Example 1 were used except the loofah fiber emulsion was made by the following method: the loofah in the mass ratio of 3:1 was mixed with water; the mixture was beaten and homogenized to obtain a slurry. To the slurry were added, the emulsifier, tea tree oil, and dopamine hydrochloric acid buffer. The slurry was stirred at 25° C. for 6 h and homogenized. The mass ratio of slurry, emulsifier, tea tree oil, and dopamine hydrochloric acid buffer was 1:0.02:0.05, the emulsifier was Tween-80, and the concentration of dopamine hydrochloride in dopamine hydrochloric acid buffer was 2 mg/ml. The concentration of trihydroxymethylaminomethane was 10 mM and the pH value was 8.5.

### Example 5

The steps described in above Example 3 were used except no tea tree oil was added.

### Example 6

The steps described above for Example 3 were used except dopamine hydrochloric acid buffer was not added.

### Example 7

The steps described above for Example 1 were used except bamboo fiber was added not added.

### Example 8

The difference from preparation example 1 is that 0.6 kg of polyglycerol sebacate was mixed with 0.7 kg of bamboo fiber, 0.3 kg of loofah fiber emulsion and antimicrobial halloysite nanotubes were mixed separately, without adding polyglycerol sebacate for electrospinning, drying, grinding and preparing antimicrobial materials.

### Example 9

The difference from Preparation Example 1 is that wormwood extract was not added.

### Example 10

The difference from Preparation Example 1 is that an equal amount of deionized water is used instead of ethanol.

### Preparation of Filler

### Example 11

(1) 0.5 kg of eggshell membrane powder was impregnated with 1 mol/L silver nitrate solution for 20 h, sodium borohydride solution was added, then stirred for 1 h, filtered, washed, and dried. Then 0.4 kg chitosan and 6 kg of acetic acid solution with a concentration of 1 wt. % were mixed evenly, pressed at a pressure of 0.12 MPA for 20 seconds, crushed, and made into modified eggshell membrane powder. Sodium borohydride solution was prepared from 0.0189 g Sodium borohydride and 50 mL of 0.1 mol/L sodium hydroxide solution. The volume ratio of sodium borohydride solution and silver nitrate solution was 1.2:1.

(2) Modified graphene oxide was prepared by mixing 1 kg of graphene oxide, 0.1 kg of surfactant, and 0.2 kg of titanium trichloride aqueous solution with a mass concentration of 15% in 10 kg of deionized water. The temperature of the mixture was raised to 180° C., and then the mixture was kept warm for 6 h. The mixture was cooled, filtered, washed, and dried to obtain the modified graphene oxide. The surfactant is nonylphenol polyoxyethylene ether ammonium oxide.

(3) The modified eggshell membrane powder made in step (1), the modified graphene oxide, 0.2 kg polyvinyl alcohol, 0.08 kg glutaraldehyde, and 5 kg deionized water made in step (2) were mixed evenly, subjected to ultrasonication for 30 min. The mixture was frozen at −20° C. for 1 h, followed by vacuum drying for 48 h. The vacuum-dried product was grounded to 2000 mesh to obtain the filler.

### Example 12

(1) modified eggshell membrane powder was prepared by impregnating 0.2 kg of eggshell membrane powder with 1 mol/L silver nitrate solution for 24 h. Then sodium borohydride solution was added, and the mixture was stirred for 2 h. Thereafter, the mixture was filtered, washed, and dried. To it was then added 0.2 kg chitosan and 5 kg of acetic acid solution in a concentration of 1 wt. %, and the mixture was mixed evenly, then pressed at a pressure of 0.08 MPa for 10 seconds to crush the solids and was obtained modified eggshell membrane powder. The sodium borohydride solution was made from 0.0189 g sodium borohydride and 50 mL of 0.1 mol/L sodium hydroxide solution and the volume ratio of sodium borohydride solution and silver nitrate solution is 1.2:1;

(2) Modified graphene oxide was obtained by mixing 1 kg of graphene oxide, 0.1 kg of surfactant, and 0.2 kg of titanium trichloride aqueous solution with a mass concentration of 15%, in 10 kg of deionized water. The mixture was heated to 180° C. and then kept warm for 6 h, followed by cooling, filtration, washing, and drying. The surfactant was nonylphenol polyoxyethylene ether ammonium oxide;

(3) The modified eggshell membrane powder made in step (1), the modified graphene oxide, 0.1 kg polyvinyl alcohol, 0.05 kg glutaraldehyde, and 4 kg deionized water were mixed well, sonicated for 20 min, and frozen at −15° C. for 2 h, then vacuum dried for 46 h, and grounded to 2000 mesh to prepare the filler.

### Example 13

The difference from Preparation Example 11 is that the shell eggshell membrane powder in step (1) is not impregnated with silver nitrate solution.

### Example 14

The difference from Example 11 is that in step (1), the modified eggshell membrane powder is impregnated by 0.5 kg of eggshell membrane powder in a silver nitrate solution with a concentration of 1 mol/l for 24 h, sodium borohydride solution was added, and stirred 2 h, filtered, washed and dried, sodium borohydride solution was made from 0.0189 g sodium borohydride and 50 mL of 0.1 mol/L sodium hydroxide solution, wherein the volume ratio of sodium borohydride solution and silver nitrate solution is 1.2:1.

### Example 15

The difference from Preparation Example 11 is that graphene oxide is not treated with titanium trichloride.

### Example 16

The difference from Preparation Example 1 1 is that without step (2), the modified eggshell membrane powder was mixed with 0.1 kg polyvinyl alcohol, 0.05 kg glutaraldehyde, and 4 kg deionized water. The mixture was sonicated for 20 min, followed by Freezing at −15° C. for 2 h, and then vacuum dried for 46 h. The resultant solids were grounded to 2000 mesh to prepare the filler.

### Example 17

The difference from Preparation Example 11 is that without step (1), the modified graphene oxide is mixed with 0.1 kg polyvinyl alcohol, 0.05 kg glutaraldehyde, and 4 kg of deionized water uniformly. The mixture was sonicated for 20 min, followed by freezing at −15° C. for 2 h, and then vacuum dried for 46 h. The resulting solids were grounded to 2000 mesh to prepare the filler.

### Preparation of Packaging Material

### Example 18

Compostable and antimicrobial packaging material for reusable or single-use packaging products was prepared. The raw material includes polylactic acid 1 kg, polybutylene terephthalate adipate 99.4 kg, antimicrobial material 1.5 kg, lubricant 0.5 kg, antioxidant 0.8 kg, filler 15 kg, plasticizer 3 kg, defoamer 0.2 kg. Polylactic acid was obtained from the United States Nature Works, code 4032D, the average molecular weight was 50,000-100,000; polybutylene terephthalate adipic acid was obtained from Tunhe, Lanshan Tunhe, Xinjiang, code is TH1801T, the average molecular weight was 10,00,000-300,000; the antimicrobial material prepared in example 1 was used; the lubricant was zinc stearate; the plasticizer was glycerin; antioxidant was antioxidant 1010; filler was made of graphene oxide with a mass ratio of 1:0.2:0.1:5, eggshell membrane powder, and polyvinyl alcohol in deionized water by mixing and drying; and the defoamer was GPE-3000 Type glycerol polyoxypropylene polyoxyethylene ether.

In step 1, polylactic acid and polybutylene terephthalate adipate were dried at 55° C. for 8 h, and then extruded and granulated to obtain a masterbatch, the extrusion temperature was 190° C.;

In step 2, the masterbatch was mixed with plasticizers, lubricants, antioxidants, fillers, and defoamers evenly, and then extruded and granulated, at extrusion temperature 205° C., to prepare compostable antimicrobial materials for reusable or single-use packaging products.

### Example 19

Compostable and antimicrobial material for reusable or single-use packaging products was prepared. Raw material included polylactic acid 5 kg, polybutylene terephthalate adipate 93.5 kg, antimicrobial material 0.6 kg, lubricant 0.1 kg, antioxidant 0.3 kg, filler 10 kg, plasticizer 1 kg, defoamer 0.1 kg. The polylactic acid was obtained from the United States Nature Works, code 4032D, with an average molecular weight of 50,000-100,000. Polybutylene terephthalate adipic acid ester was obtained from Xinjiang Lanshan Tunhe, code TH1801T, with an average molecular weight of 10-30 Million. The antimicrobial material prepared in Example 2 was used. The lubricant was polyethylene wax, the plasticizer was epoxy soybean oil, the antioxidant was antioxidant 168, and the filler was made of graphene oxide with a mass ratio of 1:0.2:0.1:5, eggshell membrane powder, and polyvinyl alcohol in deionized water, the mixture was mixed and dried. The defoamer used was GPE-3000 glycerol polyoxypropylene polyoxyethylene ether.

Preparation method of compostable antimicrobial materials for reusable or single use packaging products, including the following steps:
In step 1, polylactic acid and polybutylene terephthalic acid butylene adipate were dried at 65° C. for 6 h, and then extruded and granulate to obtain a masterbatch, wherein the extrusion temperature is 170° C.;
In step 2, the masterbatch with plasticizers, lubricants, antioxidants, fillers, and defoamers were evenly mixed, then extruded and granulate, with the extrusion temperature 205° C. to prepare compostable antimicrobial materials for reusable or single use packaging products.

### Example 20

Compostable antimicrobial material for a reusable or single use packaging product, differed from Example 18 in that the antimicrobial material prepared in Example 3 was used.

### Example 21

A compostable antimicrobial material for a reusable or single use packaging product, differed from Example 18 in that the antimicrobial material prepared in Example 4 was used.

### Example 22

A compostable antimicrobial material for a reusable or single use packaging product, differed from Example 18 in that the antimicrobial material prepared in Example 5 was used.

### Example 23

Compostable antimicrobial material for a reusable or single use packaging product, differed from Example 18 in that the antimicrobial material prepared in Example 6 was used.

### Example 24

A compostable antimicrobial material for a reusable or single use packaging product, differed from Example 18 in that the filler prepared in Example 11 was used.

### Example 25

A compostable antimicrobial material for a reusable or single use packaging product, differed from Example 20 in that the filler prepared in Example 12 was used.

### Example 26

A compostable antimicrobial material for a reusable or single use packaging product, differed from Example 20 in that the filler prepared in Example 13 was used.

### Example 27

A compostable antimicrobial material for a reusable or single use packaging product, differed from Example 20 in that the filler prepared in Example 14 was used.

### Example 28

A compostable antimicrobial material for a reusable or single use packaging product, differed from Example 20 in that the filler prepared in Example 15 was used.

### Example 29

A compostable antimicrobial material for a reusable or single use packaging product, differed from Example 20 in that the filler prepared in Example 16 was used.

### Example 30

A compostable antimicrobial material for a reusable or single use packaging product, differed from Example 20 in that the filler prepared in Example 17 was used.

Pair of Proportions

Ratio 1: A compostable antimicrobial material for a reusable or single use packaging product, differed from Example 18 in that the antimicrobial material prepared in Example 7 was used.

Ratio 2: a compostable antimicrobial material for a reusable or single use packaging product, differed from Example 18 in that the antimicrobial material prepared in Example 8 was used.

Ratio 3: A compostable antimicrobial material for a reusable or single use packaging product, differed from Example 18 in that the antimicrobial material prepared in Example 9 was used.

Ratio 4: A compostable antimicrobial material for a reusable or single use packaging product, differed from Example 18 in that the antimicrobial material prepared in Example 10 was used.

Ratio 5: A compostable antimicrobial material for reusable or single use packaging products, differed from Example 18 in that no antimicrobial material is added.

Ratio 6: a high barrier anti-stretch antimicrobial film compostable material, calculated by weight, including PBAT 45 parts, aliphatic polyester polylactic acid 12 parts, polypropylene carbonate 20 parts, antimicrobial agent 0.6 parts, compatibilizer 4 parts, antioxidant 1010 0.4 parts, erucic acid amide 0.4 parts, glycerol 5 parts, polyglycolic acid 5 parts. PBAT model is PBAT WS-PA400, melt flow rate is 4 g/10 min, polyglycolic acid purchased from Hubei Chushuo Biotechnology Co., Ltd. Polylactic acid is modified polylactic acid, wherein the modified polylactic acid was prepared as follows: (1) At 30° C., add 10 parts by weight cornstarch to 50 parts by weight of distilled water, stir for 30 min and add 0.3 parts by weight methyl oxane, and continue to stir for 40 min (During the period, maintain pH at 8.0-8.2 with 2 wt. % NaOH aqueous solution); After the reaction, the pH was adjusted to 6 with sulfuric acid, and the pretreated starch was obtained by drying. The obtained pretreated starch was added to 50 parts by weight of distilled water, and then 0.4 parts by weight (2-ethylhexenyl) succinic anhydride (CAS number: 80049-88-3), stirred at 50-60° C. for 1 h (during which 2% NaOH was used to maintain pH at 8.0-8.5), after the end of the reaction, the pH was adjusted to 6.5 with hydrochloric acid and dried to obtain modified corn starch; (2) 2 parts by weight 2-carboxyethyleneoxide acetic acid (CAS number: 94853-87-9), 15 parts by weight of polylactic acid and the modified corn starch obtained in step (1) are melt extruded from the twin screw extruder at a temperature of 170° C. and a speed of 30 r/min. Polylactic acid purchased in Nature Works in the United States, model Ingeo4032D, polypropylene carbonate article number 1010, brand is DuPont, antimicrobial agent includes silver ion antimicrobial agent and zinc salt antimicrobial agent, the weight ratio of silver ion antimicrobial agent and zinc salt antimicrobial agent is 1:1, silver ion antimicrobial agent and zinc salt antimicrobial agent by silane coupling agent treatment method, including the following steps: take silver ion antimicrobial agent (product model GA7, brand Yisheng) 1 kg of zinc salt antimicrobial agent (Brand: Esgard S+AM001-ZN) 1 kg, and 3-butenyltriethoxysilane 30 g, 1 L water and ethanol mixed solvent (the volume ratio of the two is 8:1), heated and refluxed for 5 h, the solvent is removed, dried, and then tested by wet ball milling by particle size detector until the average particle size is 80 nm when the material is discharged, and the compatibilizer is composed of citric acid and tannin acid with a mass ratio of 1:1.

The preparation method of the high-barrier anti-stretch antimicrobial film material, comprising the following steps:
Step S1: Mix PBAT, polypropylene carbonate, aliphatic carbonate and compatibilizer into Mixture Group A; The antimicrobial agent, antioxidant, and erucic acid amide were evenly mixed into group B of the mixture;
Step S2: Mixing group A is fed from the main feeding, mixing group B is fed from the side, glycerin is added from the oil pump, the three are mixed plasticized and extruded by a twin screw extruder, cooled by water, pelletized by the pelletizer, and baked in the finished product, that is, the barrel temperature of the twin screw extruder is 160° C., and the screw speed is 150 rpm.

Performance Testing Experiments

The embodiment or proportion is made into a reusable or single use packaging bag made of antimicrobial material, and the raw material dosage of the packaging bag is: PLA 90 kg, PBAT 40 kg, cornstarch 20 kg, compatibilizer 10 kg, chain extender 2 kg, antimicrobial material 15 kg, the compatibilizer is glycidyl methacrylate, PLA is selected from American Nature Works, model 4032D, PBAT selected from Tunhe, Lanshan, Xinjiang, model TH1801T, chain extender is hexamethylene diisocyanate; The preparation method is: PLA and PBAT are vacuum dried and mixed with compatibilizer, chain extender and antimicrobial materials, extruded granulation, added to the film blowing machine, extruded blown film, bag making, packaging bags, the performance of packaging bags is tested with reference to the following methods, and the test results are recorded in Table 1.

Water vapor transmission rate: according to GB/T1037-1988 “Test Method for Water Permeability of Plastic Film and Sheet”, the test conditions are 38° C., the relative humidity is 90%, the specimen diameter is 10 cm, and the test area is 63.58 cm².

Tensile strength: tested according to ASTM D882-2012 “Determination of Tensile Properties of Plastic Sheets”, the sample size is 15 mm×150 mm, the tensile rate is 100 mm/min, 5 parallel samples are tested in each group, and the average value of the test is taken.

3. Bacteriostatic rate: (1) Configure bacterial mother liquor: subculture bacteria, remove 1 ml of original bacterial solution and transfer it to 200 ml of sterilized and cooled to room temperature of the corresponding broth, culture at 37° C., 70% RH for 24 h, coating plate to determine that Escherichia coli and Staphylococcus aureus bacteria solution are 4.7×10, respectively after 7 and 5.9×107, put in the refrigerator for later; (2) Take out 0.5 ml of bacterial mother liquor, add 4.5 ml of normal saline with a concentration of 0.85%, if the concentration of bacterial mother liquor is 107 grade concentration, configure the concentration of bacterial solution is 106 grade, diluted 10 times, know the dilution to 105 grade; (3) Weigh 0.1 g packaging bags respectively, shake under the water bath shaker for 2 h (37° C., 250 r/min) and then take out the supernatant and dilute it 104/103/102 three different gradients of bacterial liquid, labeled and marked; (4) Take 103 and 102 coating plates for each sample, apply 3 parallel samples to each sample, culture at 37° C. for 24 h, calculate the number of viable bacteria, and the bacteriostatic rate is calculated according to the following formula: R=(A−B)/A×100%, where R is the bacteriostatic rate, A is the total number of bacteria, and B is the number of colonies in the bag.

TABLE 1
Performance test of packaging bags:

| | Water vapor | | | |
|---|---|---|---|---|
| | transmission | | Bacteriostatic rate/%. | |
| | rate | Tensile | coli | Staphylococcus |
| project | (g/m² · 24 h) | strength/MPa | bacillus | aureus |
| Example 1 | 385 | 11.5 | 98.9 | 99.4 |
| Example 2 | 394 | 11.3 | 98.7 | 99.1 |
| Example 3 | 334 | 11.9 | 99.5 | 99.7 |
| Example 4 | 343 | 11.8 | 99.4 | 99.7 |
| Example 7 | 302 | 12.5 | 99.9 | 99.9 |
| Example 8 | 306 | 12.4 | 99.9 | 99.9 |

It can be seen from the data in Table 1 that the antimicrobial materials prepared in Example land Example 2 are used respectively, and graphene oxide and eggshell membrane powder, polyvinyl alcohol are used to prepare fillers, and the packaging bag made thereof has good barrier to water vapor, can block oxygen, inhibit the growth and reproduction of microorganisms, and can also prevent food oxidation.

Example 3 and Example 4 respectively use the preparation of Example 3 and the preparation of Example 4 made of antimicrobial materials, on the basis of Preparation Example 1, preparation Example 3 and Preparation Example 4 using loofah slurry, tea tree oil, etc. to prepare loofah fiber emulsion, Table 1 shows that the moisture permeability of the packaging bag prepared in Example 3 and Example 4 is further reduced, the antimicrobial property is improved, and the fresh-keeping effect is improved.

Example 7 and Example 8, on the basis of Example 3, the packing prepared by Example 11 and Example 12 is used, given in Table 1, the bacteriostatic rate of Example 7 and Example 8 is increased, and the moisture permeability is reduced, indicating that the filler can enhance the barrier and bacteriostatic ability of the packaging bag.

Second, the reusable or single use effect of packaging bags:
1. Fruit and vegetable preservation cycle effect detection: after the picked grapes are transported back on the same day, immediately pre-cooled at 1-2° C. for 12 h, after removing bad fruits, rotten fruits and diseased fruits, the grapes are clearly used in tap water, and then soaked in 2% sodium hypochlorite solution for 2 min, and then washed with distilled water three times. Dry with natural ventilation, cut one 5×5×3 mm wound near the equator with a sterilized scalpel, and aspirate 10 ul of Alternaria suspension (1×10⁶) with a pipette CFU/mL) was placed on the wound, stood for 4 h, the inoculated grapes were put into a packaging bag and sealed, stored in an incubator with constant temperature and humidity at 4° C., each group treated 30 grapes, 3 replicates, calculated the rot rate at different times, and took the average of the three replicates; After the test, the bags were washed and dried with distilled water, and the above test was repeated 3 times, and the rot rate of the grapes at the third test was recorded, and the test results were recorded in Table 2.
2. Food preservation reusable or single use effect detection: according to GB2707-2005 “Hygienic Standards for Fresh (Frozen) Animal Meat”, TVB-N value (≤15 mg/100 g), take the same weight of mutton, each group of mutton weight error is ±2 g, the lamb is tightly wrapped in a packaging bag, put into (4±1) ° C. refrigerator storage, respectively, in the 2nd, 6 and 10, according to the method specified in G B/T5009.44, the lamb is determined T VB-N value, each sample is measured 3 times in parallel, the average value is taken, the freshness of the sample is judged, and then the lamb is taken out and the packaging bag is separated After cleaning the packaging bag with deionized water and drying it naturally, the same method was used to carry out the lamb preservation test 3 times, and the TVB-N value of the lamb at the 2^{nd}, 6^{th} and 10^{th} days at the 3^{rd} time was recorded. Each sample was measured three times in parallel, averaged, and the test results were recorded in Table 2.

TABLE 2
Detection of reusable effect of packaging bags

| | Fruits and vegetables are | | | Fruits and vegetables are | | |
|---|---|---|---|---|---|---|
| Decay | kept fresh for the first time | | | kept fresh for the third time | | |
| rate/% | 7 d | 13 d | 19 d | 7 d | 13 d | 19 d |
| Example 1 | 0 | 3.5 | 6.8 | 3.1 | 5.6 | 10.8 |
| Example 2 | 0 | 3.8 | 7.1 | 3.4 | 5.9 | 11.2 |
| Example 3 | 0 | 1.8 | 3.7 | 2.2 | 4.2 | 6.9 |
| Example 4 | 0 | 1.9 | 3.8 | 2.3 | 4.3 | 7.1 |
| Example 5 | 0 | 2.5 | 3.4 | 2.8 | 4.8 | 8.8 |
| Example 6 | 0 | 2.2 | 3.2 | 2.5 | 4.5 | 8.1 |
| Example 7 | 0 | 0 | 2.2 | 1.0 | 3.1 | 5.3 |
| Example 8 | 0 | 0 | 2.5 | 1.3 | 3.2 | 5.2 |
| Example 9 | 0 | 1.1 | 3.1 | 1.8 | 3.5 | 5.8 |
| Example 10 | 0 | 1.5 | 2.8 | 1.5 | 3.6 | 5.9 |
| Example 11 | 0 | 1.2 | 3.2 | 1.7 | 3.7 | 6.1 |
| Example 12 | 0 | 1.4 | 3.5 | 1.9 | 3.9 | 6.3 |
| Example 13 | 0 | 1.5 | 3.4 | 2.0 | 3.9 | 6.2 |
| Pair scale 1 | 2.8 | 5.7 | 10.4 | 5.1 | 8.4 | 14.8 |
| Pair scale 2 | 2.5 | 4.8 | 9.5 | 5.3 | 8.1 | 13.4 |
| Pair ratio 3 | 8.4 | 16.5 | 28.1 | 11.5 | 19.8 | 32.4 |
| Pair scale 4 | 11.8 | 20.4 | 30.5 | 14.5 | 23.5 | 38.1 |
| Pair scale 5 | 33.5 | 67.4 | 100 | 53.2 | 98.3 | 100 |
| Pair scale 6 | 14.3 | 34.1 | 85.3 | 43.7 | 76.3 | 100 |

Continued from table 2:

| | Food is kept fresh for the | | | Food is kept fresh for the | | |
|---|---|---|---|---|---|---|
| TVB-N | first time | | | third time | | |
| (mg/100 g) | 2 d | 6 d | 10 d | 2 d | 6 d | 10 d |
| Example 1 | 5.2 | 8.5 | 12.5 | 7.8 | 11.2 | 15.2 |
| Example 2 | 5.6 | 8.8 | 12.9 | 7.9 | 11.5 | 15.6 |
| Example 3 | 4.2 | 7.5 | 11.1 | 7.1 | 10.5 | 14.3 |
| Example 4 | 4.3 | 7.6 | 11.3 | 7.3 | 10.7 | 14.4 |
| Example 5 | 4.8 | 8.1 | 11.8 | 7.6 | 10.9 | 14.8 |
| Example 6 | 4.7 | 7.9 | 11.6 | 7.5 | 11.1 | 14.9 |
| Example 7 | 3.2 | 5.2 | 8.5 | 5.1 | 8.5 | 11.6 |
| Example 8 | 3.3 | 5.4 | 8.8 | 5.3 | 8.6 | 11.9 |
| Example 9 | 3.5 | 6.8 | 10.1 | 6.5 | 9.5 | 12.8 |
| Example 10 | 3.6 | 6.2 | 9.8 | 6.7 | 9.8 | 12.4 |
| Example 11 | 3.4 | 5.5 | 8.7 | 5.4 | 8.7 | 11.8 |
| Example 12 | 3.8 | 7.1 | 10.5 | 6.8 | 9.8 | 13.5 |
| Example 13 | 4.1 | 6.9 | 10.8 | 6.6 | 10.2 | 13.8 |
| Pair scale 1 | 6.4 | 9.1 | 13.5 | 8.4 | 12.5 | 16.8 |
| Pair scale 2 | 6.8 | 9.7 | 13.8 | 8.9 | 12.7 | 16.3 |
| Pair ratio 3 | 8.7 | 12.5 | 18.5 | 10.5 | 14.8 | 22.8 |
| Pair scale 4 | 5.8 | 8.7 | 13.0 | 7.9 | 11.5 | 15.7 |
| Pair scale 5 | 10.3 | 15.5 | 34.5 | 13.4 | 21.2 | 40.5 |
| Pair scale 6 | 8.5 | 14.5 | 24.8 | 12.8 | 19.8 | 38.8 |

Combined with the decay rate of the first preservation and the third preservation of fruits and vegetables in Table 2, it can be seen that after the antimicrobial material prepared in Example 1 and Example 2 of the present application is made into a packaging bag, the initial preservation effect of fruits and vegetables is good, the rot rate of grapes within one week is 0, and when used three times, the rot rate on the 7^{th} day can still reach less than 5%, and when it is kept fresh to 19 days, The rot rate of grapes is still controlled within 15%, indicating that the initial preservation effect of the packaging bag is good, and after repeated use, it still has a better preservation effect; The same embodiment 1 and 2 also have a good initial antimicrobial preservation effect for fresh meat, and after 3 times of use, the fresh-keeping ability of fresh meat is strong.

Example 3 and Example 4 respectively using the bacteriostatic material prepared by Preparation Example 3 and Preparation Example 4, Preparation Example 3 and Preparation Example 4 using tea tree oil, dopamine hydrochloric acid buffer mixed with loofah slurry to prepare loofah fiber emulsion, Table 2 shows that the packaging bag prepared in Example 3 and Example 4 has a good preservation effect for the initial use of fruits and vegetables and fresh meat, better than the initial preservation effect of Example 1, after 3 times of use, The fresh-keeping effect is still improved compared with Example 1, indicating that loofah fiber emulsion can improve the long-term antimicrobial and fresh-keeping ability of the packaging bag, so that the packaging bag still has a strong antimicrobial and fresh-keeping effect after multiple uses.

Example 5 and Example 6 respectively using the preparation of Example 5 and preparation Example 6 prepared antimicrobial material, compared with Example 3, tea tree oil and dopamine hydrochloric acid buffer were not added when preparing loofah fiber emulsion, Table 2 shows that when the packaging bag prepared in Example 5 is first used, the rot rate at the 1^{st}-3 d is increased than Example 3, and the subsequent use is higher than that of Example 3 The high rot rate at the same time indicates that the addition of tea tree oil can significantly enhance the initial preservation effect of the packaging bag and the preservation effect of repeated use. Similarly, the preservation effect of the first use and the third use in Example 6 is not as good as Example 3, and the preservation effect of Example 5 and Example 6 for fresh meat is not as good as Example 3.

Example 7 and Example 8 Compared with Example 3, respectively, a filler made of preparation Example 1 and Example 12 is used, Table 2 shows that the rot rate of fruits and vegetables reaches 0% on day 1 3, and at the third use, on day 19, The rot rate is still controlled within 10%, and when used again, it still has a strong antimicrobial and fresh-keeping ability, and the fresh-keeping ability of fresh meat has also increased, indicating that the use of graphene oxide loaded titanium dioxide, eggshell membrane powder loaded silver particles, the use of chitosan and polyvinyl alcohol to make a network structure, improve the slow-release effect of titanium dioxide and other components, extend the release time of antimicrobial and fresh-keeping ingredients, and make the packaging The antimicrobial and fresh-keeping ability of the bag is further improved.

Example 9 uses a filler made of preparation Example 13, wherein silver ions are not loaded on the eggshell membrane powder, and a filler made of Example 14 is used in Example 10, the eggshell membrane powder impregnated with silver nitrate solution is not mixed with chitosan and extruded into granules, Table 2 shows, Example 9 and Example 10 The prepared packaging bag, for fruits and vegetables and fresh meat preservation ability is not as good as Example 7.

Example 11 uses a filler made of Example 15, wherein titanium dioxide is not loaded on graphene oxide, Table 2 shows that the packaging bag made of Example 11 is not as fresh as Example 7 for fruits and vegetables, and the ability to keep fresh for the reuse of fruits and vegetables is reduced, However, it has little effect on the ability of fresh meat to preserve freshness again.

Example 12 and Example 13 Compared with Example 7, the filler is not added with titanium dioxide-loaded graphene oxide and silver-loaded eggshell film powder, respectively, embodiment 12 and embodiment 13 prepared packaging The initial fresh-keeping capacity of the bag for fruits and vegetables and fresh meat is not as good as Example 7, Example 9 and Example 11, and after repeated use, the fresh-keeping capacity is not as good as Example 7, Example 9 and Example 11, indicating that graphene oxide containing titanium dioxide and eggshell membrane powder containing silver can improve packaging The initial and long-lasting freshness of the bag.

Compared with Example 1, the packaging bag prepared for ratio 1 and ratio 3 has a decrease in the freshness retention ability of grapes, and the rot rate of grapes increases, and after three uses, the rot rate increases significantly, indicating that bamboo fiber and wormwood extract have a significant effect on the packaging bag Strong antimicrobial and fresh-keeping improvement effect.

The difference between ratio 2 and Example 1 is that the antimicrobial material made of preparation Example 8 is used, and the poly(glyceryl sebacate) is not electro-spun, and it is directly blended with raw materials such as bamboo fiber, and the packaging bag prepared by ratio 2 has a decrease in the fresh-keeping ability of grapes and fresh meat, an increase in the rot rate of grapes, and an increase in the TVB-N value of fresh meat, indicating that P made of electrospinning GS fiber and bamboo fiber are staggered to form a porous structure, which can improve the long-term preservation effect of packaging bags.

For the use of antimicrobial materials made of Example 10 in Ratio 4, ethanol is not added, and the packaging bag made therefrom has a decrease in the fresh-keeping ability of fruits and vegetables, and after three uses, the fresh-keeping capacity is not as good as the fresh-keeping ability after three uses in Example 1, but it has little effect on the fresh-keeping ability of fresh meat.

No antimicrobial material is added to the proportion 5, and the fresh-keeping capacity of the packaging bag prepared for the ratio 5 is not as good as the proportion 6 with the addition of antimicrobial agent, and it is not as good as Example 1 and Example 7 of the present application.

For packaging bags made of degradable materials prepared by prior art in proportion 6, although antimicrobial agents are added therein, their preservation and bacteriostatic ability for fruits and vegetables and fresh meat is not as good as the present application.

The present embodiment is only an interpretation of the present application, which is not a limitation of the present application, those skilled in the art may make modifications to the present embodiment without inventive contribution as needed after reading the present specification, but as long as they are protected by patent law within the scope of the claims of the present application.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A compostable and antimicrobial material for packaging comprising:
1-5 parts polylactic acid, 93.5-99.4 parts of polybutylene terephthalate adipate, 0.6-1.5 parts of antimicrobial material, 0.1-0.5 parts of lubricant, 0.3-0.8 parts of antioxidant, 10-15 parts of filler, 1-3 parts of plasticizer, Defoamer 0.1-0.2 parts, antihydrolytic agent 0.5-1 part.

2. The compostable and antimicrobial packaging material of claim 1, wherein the antimicrobial material comprises the following parts by weight of components: 1-2 parts of halloysite nanotubes, 0.2-0.5 wormwood extract, 1.5-2 parts of ethanol, 0.3-0.6 parts of polyglyceryl sebacate, 0.4-0.7 parts of bamboo fiber, and 0.1-0.3 parts of loofah fiber emulsion.

3. The compostable and antimicrobial packaging material of claim 2, wherein the filler comprises in a mass ratio of 1:(0.2-0.5):(0.1-0.2) graphene oxide, eggshell membrane powder and polyvinyl alcohol.

4. The compostable and antimicrobial packaging material of claim 3, wherein the lubricant is selected from a group consisting of N,N-methylenebistearamide, polyethylene wax, zinc stearate, and a combination thereof; the plasticizer is selected from a group consisting of glycerol, epoxy soybean oil, tributyl citrate, and a combination thereof; the defoamer is selected a group consisting of silicon ether copolymer defoamer, modified polydimethylsiloxane and glycerol polyoxypropylene polyoxyethylene ether, and a combination thereof.

5. The compostable and antimicrobial packaging material of claim 4, wherein the antioxidant is antioxidant 1010, antioxidant 168, or a combination thereof.

6. The compostable and antimicrobial packaging material of claim 5, wherein the anti-hydrolyzing agent is Hy Max1010 type anti-hydrolytic agent.

7. The compostable and antimicrobial packaging material of claim 1, wherein average molecular weight of polylactic acid is 500,000-100,000; and average molecular weight of polybutylene terephthalate adipate is 100,000-300,000.

8. A method of preparing compostable and antimicrobial packaging material, the method comprises:
mixing halloysite nanotubes with wormwood extract and ethanol to obtain a mixture;
subjecting the mixture to vacuum at 0.1-0.2 MPa and stirred for 30-45 min; and
upon stirring under vacuum, restoring the mixture to normal pressure and stirring for 15-20 minutes.

9. The method of preparing compostable and antimicrobial packaging material of claim 8, wherein the method further comprises:
upon stirring under normal pressure, subjecting the mixture second time to vacuum at 0.1-0.2 MPa and stirred for 30-45 min;
upon stirring under vacuum for second time, restoring the mixture to normal pressure and stirring for 15-20 minutes;
upon stirring under normal pressure, subjecting the mixture third time to vacuum at 0.1-0.2 MPa and stirred for 30-45 min; and
upon stirring under vacuum for third time, restoring the mixture to normal pressure and stirring for 15-20 minutes.

10. The method of preparing compostable and antimicrobial packaging material of claim 8, wherein the method further comprises:
upon stirring under normal pressure, filtering the mixture to obtain antimicrobial halloysite nanotubes;
dissolving polyglycerol sebacate in hexafluoroisopropanol to obtain a spinning liquid;
electrospinning the spinning liquid to obtain PGS fiber; and
mixing the PGS fiber, bamboo fiber, loofah fiber emulsion, and the antimicrobial halloysite nanotubes to obtain an antimicrobial material.

11. The method of preparing compostable and antimicrobial packaging material of claim 10, wherein the loofah fiber emulsion is prepared by:
mixing, beating, and homogenizing loofah and water to obtain a slurry;
adding emulsifier, tea tree oil, and dopamine hydrochloric acid buffer to the slurry; and
upon adding, stirring the slurry at 25-30° C. for 5-6 h.

12. The method of preparing compostable and antimicrobial packaging material of claim 11, wherein mass ratio of the emulsifier, the tea tree oil and the dopamine hydrochloric acid buffer in the slurry is 1:(0.02-0.03):(0.05-0.1).

13. The method of preparing compostable and antimicrobial packaging material of claim 10, wherein the method comprises:
extruding and granulating polylactic acid and polybutylene terephthalic acid butylene glycol terephthalate to obtain a masterbatch;
mixing the masterbatch with antimicrobial halloysite nanotubes, plasticizers, lubricants, antioxidants, fillers, and defoamers to obtain a masterbatch mixture; and
upon mixing, granulating by extrusion the masterbatch mixture to obtain the compostable and antimicrobial packaging material.

14. The method of preparing compostable and antimicrobial packaging material of claim 13, wherein the polylactic acid and polybutylene terephthalic acid butylene glycol terephthalate is extruded at 170-190° C.

15. The method of preparing compostable and antimicrobial packaging material of claim 13, wherein the masterbatch mixture comprises following parts by weight: 1-5 parts polylactic acid, 93.5-99.4 parts of polybutylene terephthalate adipate, 0.6-1.5 parts of antimicrobial material, 0.1-0.5 parts of lubricant, 0.3-0.8 parts of antioxidant, 10-15 parts of filler, 1-3 parts of plasticizer, Defoamer 0.1-0.2 parts, antihydrolytic agent 0.5-1.0 part.

16. The method of preparing compostable and antimicrobial packaging material of claim 15, wherein the filler comprises in a mass ratio of 1:(0.2-0.5):(0.1-0.2) graphene oxide, eggshell membrane powder and polyvinyl alcohol; wherein the filler is prepared by:
impregnating eggshell membrane powder with silver nitrate solution for 20-24 h;
adding sodium borohydride solution and stirring for 1-2 h to obtain solids;
mixing the solids with chitosan and 1.5 wt. % acetic acid solution;
grounding under pressure to obtain modified eggshell membrane powder;
mixing graphene oxide, surfactant, and titanium trichloride in deionized water at 180-190° C. to obtain modified graphene oxide; and
mixing the modified eggshell membrane powder, the modified graphene oxide, polyvinyl alcohol, glutaraldehyde, and deionized water to obtain the filler.

17. The method of preparing compostable and antimicrobial packaging material of claim 16, wherein the lubricant is selected from a group consisting of N,N-methylenebistearamide, polyethylene wax, zinc stearate, and a combination thereof.

18. The method of preparing compostable and antimicrobial packaging material of claim 17, wherein the plasticizer is selected from a group consisting of glycerol, epoxy soybean oil, tributyl citrate, and a combination thereof.

19. The method of preparing compostable and antimicrobial packaging material of claim 18, wherein the defoamer is selected a group consisting of silicon ether copolymer defoamer, modified polydimethylsiloxane and glycerol polyoxypropylene polyoxyethylene ether, and a combination thereof.

20. The method of preparing compostable and antimicrobial packaging material of claim 19, wherein the antioxidant is antioxidant 1010, antioxidant 168, or a combination thereof.
